(19) United States
(12) Patent Application Publication
(10) Pub. No.: US 2025/0271114 A1
(43) Pub. Date: Aug. 28, 2025

(54) VEHICLE HEADLAMP

(71) Applicant: KOITO MANUFACTURING CO., LTD., Tokyo (JP)

(72) Inventors: Takaaki SATO, Shizuoka (JP); Teppei MURAMATSU, Shizuoka (JP)

(21) Appl. No.: 19/026,523

(22) Filed: Jan. 17, 2025

(30) Foreign Application Priority Data
Feb. 22, 2024 (JP) 2024-025174

(51) Int. Cl. F21S 41/43; F21S 41/25; F21S 41/32

(52) U.S. Cl. CPC F21S 41/43; F21S 41/25; F21S 41/32

(57) ABSTRACT

A vehicle headlamp includes a light source that emits light, a reflector that reflects the light emitted from the light source, a shade that blocks a portion of the light reflected by the reflector, and a projection lens that projects the light reflected by the reflector. The shade is provided with a control end located on a side of the light source. The control end includes a reflective control surface subjected to a reflective treatment and having a focal point of light positioned thereon or in the vicinity thereof, and a sloped surface subjected to a reflective treatment and continuous with an edge of the reflective control surface on the side of the light source. The sloped surface is inclined with respect to the reflective control surface to be displaced downward as a distance from the reflective control surface increases.

### CROSS-REFERENCE TO RELATED APPLICATIONS

This application is based on and claims priority from Japanese Patent Application No. 2024-025174, filed on Feb. 22, 2024, with the Japan Patent Office, the disclosure of which is incorporated herein in its entirety by reference.

### TECHNICAL FIELD

The present disclosure relates to a technical field concerning a vehicle headlamp in which light emitted from a light source is reflected by a reflector and a portion of the light is blocked by a shade.

### BACKGROUND

There is a type of vehicle headlamp in which a lamp unit, which includes a reflector and a shade, is arranged in the interior of a lighting device outer case, which is constituted with a cover and a lamp housing (see, e.g., Japanese Patent Laid-Open Publication No. 2012-059643). In the vehicle headlamp described in Japanese Patent Laid-Open Publication No. 2012-059643, a reflector, a shade, a projection lens, and other components are arranged in the interior of the lighting device outer case, light emitted from a light source is reflected by the reflector toward the shade where a portion of the light is blocked, while the unblocked light is controlled and directed outward as substantially parallel rays from the projection lens.

### SUMMARY

In the vehicle headlamp equipped with the shade as described in Japanese Patent Laid-Open Publication No. 2012-059643, since the focal point of light reflected by the reflector is positioned on or near the surface of one end (control end) of the shade on the light source side, heat may be accumulated in the control end depending on the incidence of light.

In particular, when the angle of incidence of light with respect to an incident surface is or is close to a perpendicular angle, the illuminance is likely to increase, which may cause issues such as melting and discoloration in the area with the increased illuminance.

Therefore, a vehicle headlamp of the present disclosure aims to prevent melting and discoloration in the control end.

According to one aspect of the present disclosure, a vehicle headlamp includes a light source that emits light, a reflector that reflects the light emitted from the light source, a shade that blocks a portion of the light reflected by the reflector, and a projection lens that projects the light reflected by the reflector. The shade is provided with a control end located on a side of the light source. The control end includes a reflective control surface subjected to a reflective treatment and having a focal point of light positioned thereon or in the vicinity thereof, and a sloped surface subjected to a reflective treatment and continuous with an edge of the reflective control surface on the side of the light source. The sloped surface is inclined with respect to the reflective control surface to be displaced downward as a distance from the reflective control surface increases.

Thus, the angle of incidence of light with respect to the sloped surface, which is inclined with respect to the reflective control surface, becomes smaller.

According to another aspect of the present disclosure, a vehicle headlamp includes a light source that emits light, a reflector that reflects the light emitted from the light source, a shade that blocks a portion of the light reflected by the reflector, and a projection lens that projects the light reflected by the reflector. The shade is provided with a control end located on a side of the light source. The control end includes a reflective control surface subjected to a reflective treatment and having a focal point of light positioned thereon or in the vicinity thereof, and a tip surface that enables incidence of light in a direction different from the reflective control surface. The shade is made of a transparent material.

Thus, the incident light on the tip surface passes through the control end.

According to the present disclosure, it is possible to prevent melting and discoloration in the control end.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates, along with FIGS. 2 to 4, a first embodiment of a vehicle headlamp according to the present disclosure, in a cross-sectional view of the vehicle headlamp.

FIG. 2 is a cross-sectional view of a shade.

FIG. 3 is a cross-sectional view illustrating an example in which the shade is made of a transparent material.

FIG. 4 is a cross-sectional view of the shade illustrating another example of a control end.

FIG. 5 illustrates, along with FIG. 6, a second embodiment of a vehicle headlamp according to the present disclosure, in a cross-sectional view of the vehicle headlamp.

FIG. 6 is a cross-sectional view of a shade.

### DETAILED DESCRIPTION

In the following detailed description, reference is made to the accompanying drawings which form a part hereof. The illustrative embodiments described in the detailed description, drawings, and claims are not meant to be limiting. Other embodiments may be utilized, and other changes may be made without departing from the spirit or scope of the subject matter presented herein.

Hereinafter, embodiments for implementing a vehicle headlamp of the present disclosure will be described with reference to the accompanying drawings.

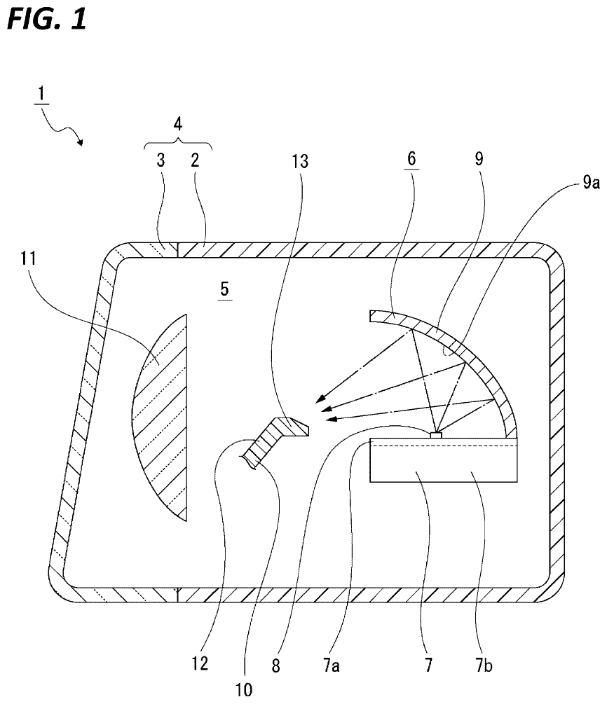

First, a vehicle headlamp 1 according to a first embodiment will be described (see, e.g., FIGS. 1 to 4).

The vehicle headlamp 1 includes a lamp housing 2 with an opening at a front end thereof and a cover 3 that closes the opening of the lamp housing 2 (see, e.g., FIG. 1). The lamp housing 2 and the cover 3 constitute a lighting device outer case 4, and the internal space of the lighting device outer case 4 is formed as a lamp chamber 5.

A lamp unit 6 is arranged in the lamp chamber 5. The lamp unit 6 includes a heat sink 7, a light source 8, a reflector 9, a shade 10, and a projection lens 11.

The heat sink 7 is made of, for example, a metallic material with high thermal conductivity, and includes a plate-shaped base portion 7a that faces upward and downward and a plurality of heat dissipation fins 7b protruding downward from the base portion 7a. The heat dissipation fins 7b are arranged, for example, side by side in the left-right direction.

As for the light source 8, for example, a light-emitting diode (LED) is used. The light source 8 is mounted, for example, on a circuit board (not illustrated). The circuit board is disposed on the base portion 7a of the heat sink 7.

The reflector 9 is attached at a rear lower end thereof, for example, to a rear end of the base portion 7a. An inner surface of the reflector 9 is formed as a reflective surface 9a. Light emitted from the light source 8 is reflected by the reflective surface 9a toward the shade 10.

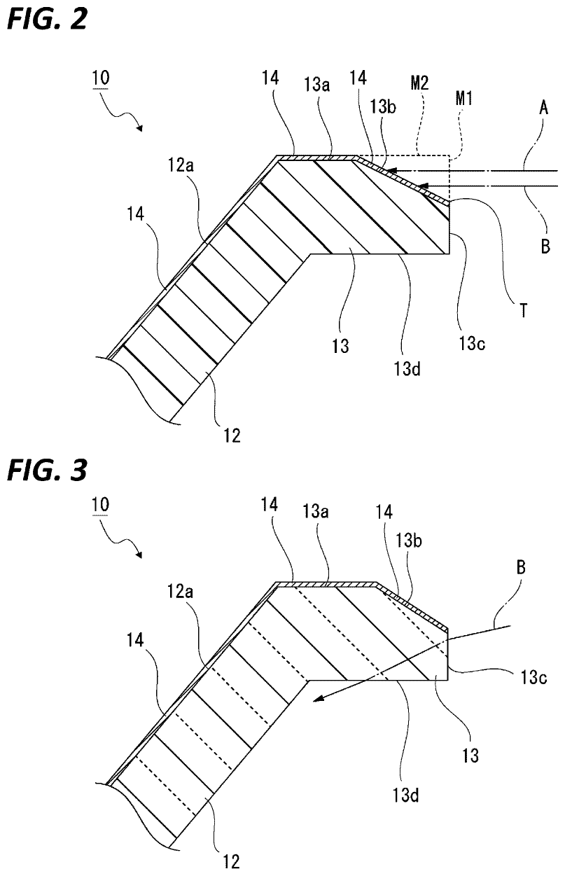

The shade 10 is made of, for example, a colored resin material such as polycarbonate, and includes an inclined portion 12 extending diagonally with respect to the horizontal and vertical directions, and a control end 13 continuous with a rear end of the inclined portion 12 (see, e.g., FIGS. 1 and 2). The inclined portion 12 is displaced upward to the rear, while the control end 13 protrudes rearward from the rear end of the inclined portion 12.

The control end 13 includes an upward-facing reflective control surface 13a, a sloped surface 13b continuous with the rear edge of the reflective control surface 13a, a tip surface 13c continuous with the rear edge of the sloped surface 13b, and a lower surface 13d continuous with the lower edge of the tip surface 13c (see, e.g., FIG. 2).

The front edge of the reflective control surface 13a is continuous with the rear edge of an upper surface of the inclined portion 12, and a reflective treatment 14 such as metal vapor deposition is applied to the reflective control surface 13a. Thus, incident light on the reflective control surface 13a is reflected. The focal point of light reflected by the reflective surface 9a of the reflector 9 is positioned on or near the reflective control surface 13a. Therefore, the reflective surface 9a is a necessary surface for ensuring proper optical performance in the vehicle headlamp 1 and requires a certain length in the front-rear direction.

The sloped surface 13b is inclined with respect to the reflective control surface 13a, so as to be displaced downward to the rear. The reflective treatment 14 such as metal vapor deposition is applied to the sloped surface 13b. Thus, incident light on the sloped surface 13b is reflected.

The tip surface 13c is formed as a rearward-facing surface. The reflective treatment is not applied to the tip surface 13c and the lower surface 13d.

Further, in the shade 10, the reflective treatment 14 may also be applied to an upper surface 12a of the inclined portion 12. By applying the reflective treatment 14 to the upper surface 12a, it is possible to use the upper surface 12a, for example, as a reflective surface for generating overhead sign light or other purposes.

The projection lens 11 is positioned on the side of the shade 10 opposite the light source 8. At least light controlled by the control end 13 of the shade 10 enters the projection lens 11. The projection lens 11 has the function of controlling and projecting incident light into approximately parallel rays.

In the vehicle headlamp 1 configured as described above, when light is emitted from the light source 8, the emitted light is reflected by the reflective surface 9a of the reflector 9 toward the shade 10, where a portion of the light is blocked. The unblocked light is controlled by the control end 13 of the shade 10, or passes near the control end 13 to enter the projection lens 11. The projection lens 11 controls the light into approximately parallel rays, and projects them forward through the cover 3.

When light is emitted from the light source 8, a portion of light reflected by the reflective surface 9a of the reflector 9 is directed as light A in an approximately horizontal state toward the control end 13. The light A, directed in an approximately horizontal state toward the control end 13, enters the sloped surface 13b and the tip surface 13c of the control end 13. However, because the sloped surface 13b is inclined, the light A enters the sloped surface 13 in directions other than the perpendicular direction.

At this time, if the sloped surface 13b were not formed and the control end 13 instead had a shape composed of a rearward-facing surface M1 extending from the tip surface 13c and an upward-facing surface M2 extending from the reflective control surface 13a as illustrated by the dotted lines in FIG. 2, the light A would enter the small-area surface M1 from a direction perpendicular (approximately perpendicular) thereto, which would result in a high illuminance in the surface M1.

However, because the control end 13 of the vehicle headlamp 1 includes the sloped surface 13b instead of the surfaces M1 and M2, the light A enters the sloped surface 13b, which has a larger area than the surface M1, in directions other than the perpendicular direction. This reduces the light intensity per unit area on the sloped surface 13b, resulting in a reduction in illuminance. Consequently, heat accumulation in the control end 13 is minimized even when the light A enters the control end 13.

As described above, in the vehicle headlamp 1, the control end 13 of the shade 10 includes the reflective control surface 13a with the reflective treatment 14 applied, on or near which the focal point of light is positioned, and the sloped surface 13b with the reflective treatment 14 applied, which is continuous with the edge of the reflective control surface 13a on the light source 8 side, and the sloped surface 13b is inclined with respect to the reflective control surface 13a so as to be displaced downward with an increasing distance from the reflective control surface 13a.

Thus, the angle of incidence of light on the large-area sloped surface 13b inclined with respect to the reflective control surface 13a is reduced, lowering the illuminance on the sloped surface 13b. This minimizes heat accumulation in the control end 13, mitigating issues such as melting and discoloration caused by the peeling of reflective treatment 14 due to heat in the control end 13.

Further, the control end 13 is formed with the tip surface 13c, which is continuous with the edge of the sloped surface 13b on the light source 8 side and faces a direction different from that of the sloped surface 13b, for example, faces rearward.

Thus, with the formation of the tip surface 13c, the edge of the control end 13 on the light source 8 side does not form a sharp protrusion (protrusion T illustrated in FIG. 2). This ensures high strength of the control end 13 while preventing melting and discoloration in the control end 13.

Further, in the vehicle headlamp 1, the shade 10 may also be made of a transparent material (see, e.g., FIG. 3). When the shade 10 is made of a transparent material, light B reaching the tip surface 13c enters the interior of the control end 13 from the tip surface 13c, and at least a portion of the light passes through the control end 13. Consequently, by allowing at least a portion of the light B to pass through the control end 13, heat accumulation in the control end 13 is minimized. Additionally, the sloped surface 13b lowers the illuminance, further minimizing heat accumulation in the control end 13. With the shade 10 made of a transparent material, heat accumulation in the control end 13 may be effectively minimized.

This configuration sufficiently minimizes heat accumulation in the control end 13. Therefore, the area of the sloped surface 13b may be reduced, allowing the area of the reflective control surface 13a to be increased, thereby improving the strength of the control end 13. Consequently, the high strength of the control end 13 is ensured while sufficiently minimizing heat accumulation in the control end 13.

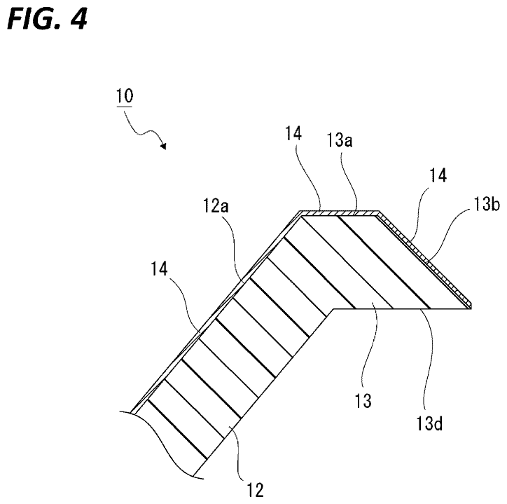

Further, in the shade 10, the rear edge of the sloped surface 13b may be aligned with the lower edge (rear edge of the lower surface 13d) of the control end 13, and the control end 13 may be configured without the tip surface 13c (see, e.g., FIG. 4). By adopting this configuration of the shade 10, the area of the sloped surface 13b may be maximized, significantly reducing the illuminance of incident light on the sloped surface 13b. This may efficiently prevent melting and discoloration of the control end 13.

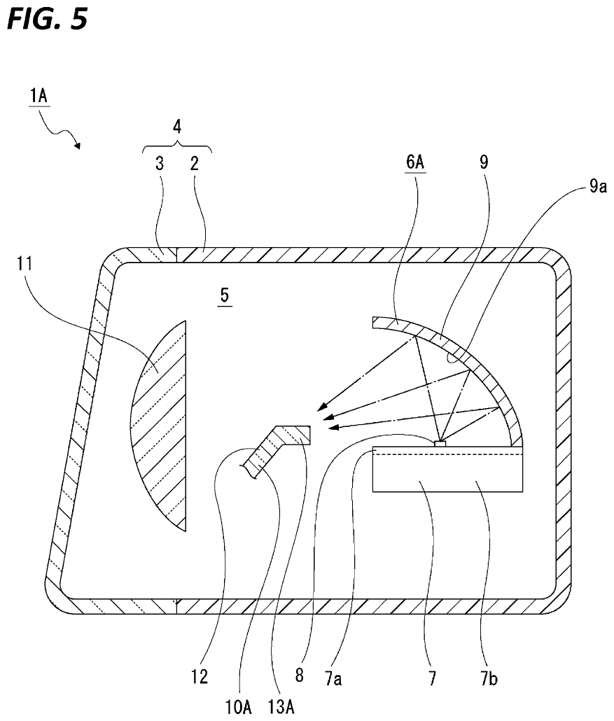

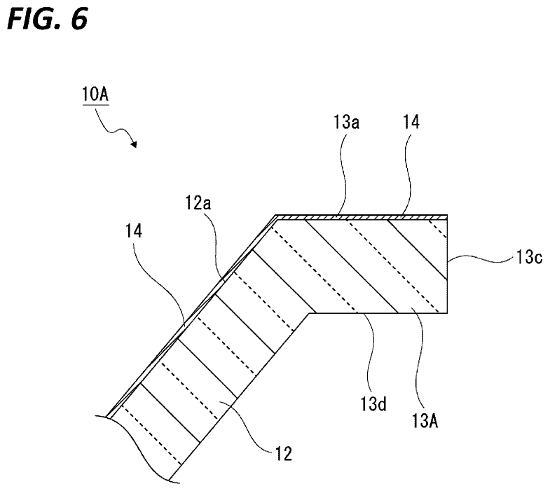

Next, a vehicle headlamp 1A according to a second embodiment will be described (see, e.g., FIGS. 5 and 6).

Moreover, the vehicle headlamp 1A described below differs from the aforementioned vehicle headlamp 1 only in the configuration of the shade. Therefore, only the differences from the vehicle headlamp 1 will be described in detail, while other components will be designated by the same reference numerals as those used for similar components in the vehicle headlamp 1, and description thereof will be omitted.

A lamp unit 6A is arranged in the lamp chamber 5. The lamp unit 6A includes the heat sink 7, the light source 8, the reflector 9, a shade 10A, and the projection lens 11.

The shade 10A is made of a transparent material and includes the inclined portion 12 and a control end 13A. The control end 13A protrudes rearward from the rear end of the inclined portion 12.

The control end 13A includes the upward-facing reflective control surface 13a, the rearward-facing tip surface 13c continuous with the rear edge of the reflective control surface 13a, and the downward-facing lower surface 13d continuous with the lower edge of the tip surface 13c. The reflective treatment 14 is applied to the reflective control surface 13a, but not applied to the tip surface 13c and the lower surface 13d.

In the vehicle headlamp 1A configured as described above, when light is emitted from the light source 8, the emitted light is reflected by the reflective surface 9a of the reflector 9 toward the shade 10A, where a portion of the light is blocked by the shade 10A. The unblocked light is controlled by the control end 13a of the shade 10A, or passes near the control end 13a to enter the projection lens 11. The projection lens 11 controls the light into approximately parallel rays, and projects them forward through the cover 3.

When light is emitted from the light source 8, a portion of light reflected by the reflective surface 9a of the reflector 9 enters the interior of the control end 13a through the tip surface 13c. At least a portion of the light passes through the control end 13a. Consequently, heat accumulation in the control end 13a is minimized.

As described above, in the vehicle headlamp 1A, the control end 13a of the shade 10A includes the reflective control surface 13a with the reflective treatment 14 applied, on or near which the focal point of light is positioned, and the tip surface 13c that enables light to enter in a direction different from the reflective control surface 13a. The shade 10A is made of a transparent material.

Consequently, light entering the tip surface 13c passes through the control end 13a, reducing the likelihood of heat accumulation in the control end 13a. This may prevent melting and discoloration caused by the peeling of reflective treatment 14 due to heat in the control end 13a.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A vehicle headlamp comprising:
a light source configured to emit light;
a reflector configured to reflect the light emitted from the light source;
a shade configured to block a portion of the light reflected by the reflector; and
a projection lens configured to project the light reflected by the reflector,
wherein the shade is provided with a control end located on a side of the light source,
the control end includes a reflective control surface subjected to a reflective treatment and having a focal point of light positioned thereon or in a vicinity thereof, and a sloped surface subjected to a reflective treatment and continuous with an edge of the reflective control surface on the side of the light source, and
the sloped surface is inclined with respect to the reflective control surface to be displaced downward as a distance from the reflective control surface increases.

2. The vehicle headlamp according to claim 1, wherein the control end is formed with a tip surface continuous with an edge of the sloped surface on the side of the light source and oriented in a direction different from that of the sloped surface.

3. The vehicle headlamp according to claim 2, wherein the shade is made of a transparent material, and enables light to enter the control end from the tip surface.

4. The vehicle headlamp according to claim 1, wherein the edge of the sloped surface on the side of the light source is aligned with a lower edge of the control end.

5. A vehicle headlamp comprising:
a light source configured to emit light;
a reflector configured to reflect the light emitted from the light source;
a shade configured to block a portion of the light reflected by the reflector; and
a projection lens configured to project the light reflected by the reflector,
wherein the shade is provided with a control end located on a side of the light source,
the control end includes a reflective control surface subjected to a reflective treatment and having a focal point of light is positioned thereon or in a vicinity thereof, and a tip surface that enables incidence of light in a direction different from the reflective control surface, and
the shade is made of a transparent material.
